(19) United States
(12) Patent Application Publication
(10) Pub. No.: US 2012/0121784 A1
(43) Pub. Date: May 17, 2012

(54) Creamer system and method of producing a creamer

(76) Inventor: Alfredo Con, South Pasadena, CA (US)

(21) Appl. No.: 10/592,273

(22) PCT Filed: Mar. 8, 2005
(86) PCT No.: PCT/US05/07510

§ 371 Date: Feb. 2, 2012

Related U.S. Application Data
(60) Provisional application No. 60/550,332, filed on Mar. 8, 2004.

(51) Int. Cl. A23C 13/14; A23L 1/19; A23C 11/02

(52) U.S. Cl. 426/548; 426/580; 426/588; 426/443

(57) ABSTRACT

A creamer system and methods of preparing and utilizing a creamer system are provided. The creamer system comprises textural ingredients, appearance ingredients, and flavor/aroma ingredients that may be added in quantities sufficient to match the corresponding texture, appearance, flavor, and aroma of one or more natural creamers. The creamer system method allows the resulting creamer system to match fully and accurately the sensory profile of existing natural creamers (particularly natural dairy creamers such as fluid whole milk, fluid lowfat milk, sweetened condensed milk, and half-and-half). The creamer system method also may be used to produce a creamer system that is fully consistent with the category of existing natural creamers (particularly natural dairy creamers), even if the sensory profile does not match any actual natural creamers. The creamer system method includes the approach of modifying specific sensory attributes of the creamer system.

### BACKGROUND OF THE INVENTION

1. Field of the Invention

This invention relates to creamer systems for use in foods, and methods related to the production of a creamer. The present invention focuses on creamer systems that are designed to match fully and accurately the sensory profile of existing natural creamers. Examples of such natural creamers include without limitation dairy creamers such as fluid whole milk, fluid lowfat milk, fluid nonfat milk, sweetened condensed milk, heavy cream, light cream, and half-and-half. Furthermore, the present invention also focuses on creamer systems that are designed to have a sensory profile that is fully consistent with the category of existing natural creamers, even if the sensory profile does not match any specific actual natural creamers. For example, the present invention relates to a creamer system with a sensory profile that fully matches that of fluid whole milk, with the exception of a mouthfeel that is between that of fluid whole milk and half-and-half. The present invention also focuses on creamer systems that may be customized to create sensory profiles that do not match either existing actual natural creamers or categories of actual natural creamers, but nevertheless have a pleasant sensory profile.

The creamer systems on which this invention focuses may be designed to have a much lower cost and bulk density than equivalent natural creamers. As such, these creamer systems are particularly suitable for use in a wide range of applications, including without limitation in hot-beverage vending machines and automatic beverage dispensers (collectively, “vending machines”).

2. Related Art

It is known in the art that natural creamers, particularly natural dairy creamers, impart very desirable characteristics to a wide range of foods. (The terms “food” and “foods” as used herein include beverages.) Examples of foods in which natural creamers play an essential role include, without limitation, rice puddings, sauces, flavored shakes, café au laits, cappuccinos, lattes, hot chocolate beverages, and chai tea lattes.

It is also known in the art that lower-cost, man-made creamers (hereinafter, “artificial creamers”), such as non-dairy creamers, are a very imperfect substitute for natural creamers. Artificial creamers occasionally meet or even exceed a specific sensory attribute of natural creamers (for example, Whiteness), but they fail to match fully or accurately the entire sensory profile of natural creamers. Such creamers are acceptable for sparing use in beverages, such as coffee, but are not ideal. However, when quantities of these non-dairy creamers become large enough to mimic the use of a natural creamer in a coffee beverage such as a café au lait (typically 50% coffee and 50% milk) or a latte (typically 3% espresso coffee and 97% milk), for example, the artificial flavor and various departures from the sensory profile of natural creamers become apparent, and the result is an unacceptable beverage.

It is also known in the art that, because of their bulk and high cost, natural creamers are difficult to use in many applications. The problem regarding bulk is particularly acute when the natural creamers are in powdered form (such as whole milk powder), both because such powders have a low bulk density, and because typically the bulk density of such powders has to be lowered further (e.g., by instantizing or agglomerating the powder) to improve their solubility.

The use of creamers in hot beverages (such as cappuccinos, lattes, and hot chocolates) dispensed by vending machines illustrates the limitations of natural and artificial creamers. Due to their low bulk density (particularly if instantized or agglomerated), it is impractical to use natural creamers such as whole milk powder. For example, to produce 100 kilograms of reconstituted whole milk to be used as creamer in coffee, it is necessary to use about 12.3 kilograms of whole milk powder and 87.7 kilograms of water. At a bulk density of 0.3 grams/milliliter, the 12.3 kilograms of whole milk powder represent over 40 liters of volume, a volume that is prohibitively large for existing vending machines.

The constraints of natural creamers mean that, even when vending operators choose to use natural creamers, they are unable to reconstitute them to an optimum level. For example, vending machines that use whole milk powder dispense a product with a sensory profile that is vastly different from that of fluid whole milk, because they reconstitute the powder to a level that contains far less milkfat and nonfat solids than the level in fluid whole milk.

Given the low bulk densities and relative high cost of natural creamers, most vending operators choose to use artificial creamers in their vending machines. As set forth above, artificial creamers typically provide some whitening power, but have a vastly different sensory profile from natural creamers that is unacceptable if large amounts of the artificial creamer are required in a given application.

Manufacturers of dehydrated foods requiring creamers face similar problems. Such dehydrated foods are intended to be rehydrated by the consumer; examples include without limitation powdered beverage mixes (such as hot chocolate and chai tea latte mixes), sauce bases, and dessert mixes. The solutions that these manufacturers adopt are similar to those adopted by vending operators. Typically, such manufacturers avoid natural creamers altogether; when natural creamers are used, they are used in less-than-optimal concentrations. More commonly, such manufacturers use artificial creamers, or bypass them altogether.

Great Britain Patent 1,469,541 to Gardiner discloses the addition of phosphates to a non-dairy creamer based on sodium caseinate, in order to prevent the precipitation of the non-dairy creamer in coffee. The resulting non-dairy creamer has a sensory profile that is far inferior compared to that of natural dairy creamers such as fluid whole milk and half-and-half.

U.S. Published Application No. 2003/0008053 to Singh describes a method for drying fluid milk into powdered form. The resulting powder is simply a milk powder that is no different from ordinary powdered milk, and thus no easier to use in a vending machine. As discussed above, to reconstitute milk powder to the level of dairy creamers, it is necessary to use far larger volumes than vending machines can accommodate. Furthermore, the resulting powder is no less expensive than milk powders readily available in the market. Finally, other than adjusting the reconstitution ratio, there is no way to adjust specific sensory attributes of the final creamer (for example, increasing mouthfeel without adjusting the other sensory attributes).

### SUMMARY OF THE INVENTION

An advantage of the current invention is that the sensory profile of the envisioned creamer may be designed to match fully and accurately the sensory profile of existing natural creamers. In particular, the envisioned creamer may be designed to match fully and accurately the sensory profiles of dairy creamers such as fluid whole milk, lowfat milk, half-and-half, heavy cream, and the like.

Another advantage of the current invention is that the envisioned creamer may be designed to have a sensory profile that is fully consistent with the category of existing natural creamers, even if the sensory profile does not match any actual natural creamers. For example, the envisioned creamer can be designed to have a sensory profile that fully matches that of fluid whole milk, with the exception of a mouthfeel that is between that of fluid whole milk and half-and-half.

Another advantage of the current invention is that the envisioned creamer can be customized to match fully and accurately the positive sensory attributes associated with natural creamers. In other words, the current invention can exclude negative sensory attributes from the sensory profile. For example, in Aroma and Taste dimensions, the envisioned creamer can include all positive attributes (such as Raw Cream, Salty, and Sweet) but exclude negative attributes (such as Grassy and Stale). Another advantage of the current invention is that the envisioned creamer can be customized to create sensory profiles that do not match either existing actual natural creamers or categories of actual natural creamers, but nevertheless have a pleasant sensory profile. Another advantage of the current invention is that the envisioned creamer may be designed to have a much lower cost and a higher bulk density than equivalent dried natural creamers or natural creamer categories. As such, the envisioned creamer is particularly suitable in a wide range of applications that require low cost and/or low usage volumes, such as vending machines and dehydrated foods.

According to a first aspect of the present invention, a creamer system having a sensory profile includes one or more texture components selected from the group consisting of milk powder, cream powder, milk protein, vegetable fat, animal fat, sodium alginate, propylene glycol alginate, hydrocolloids, vegetable protein, starches, hydrocolloids, and emulsifiers, said texture components affecting the texture of the creamer; one or more appearance components selected from the group consisting of milk fat, milk protein, titanium dioxide, food coloring, sodium alginate, propylene glycol alginate, and hydrocolloids, said appearance components affecting the appearance of the creamer; and one or more flavor/aroma components selected from the group consisting of concentrated milk flavor, concentrated cream flavor, natural sweetener, artificial sweetener, salt, and fatty acids, said flavor/aroma components affecting the flavor and aroma of the creamer. The preselected sensory profile of said creamer system matches a sensory profile of a natural creamer selected from the group consisting of fluid whole milk, fluid lowfat milk, fluid nonfat milk, sweetened condensed milk, heavy cream, and half-and-half when said dry creamer system is hydrated.

According to a second aspect of the present invention, a powdered creamer product includes from about 70 to about 90% by weight of cream powder; from about 7 to about 15% by weight of sugar; and from about 1.0 to about 2.0% by weight of salt.

According to a third aspect of the present invention, a powdered creamer product includes from about 70 to about 90% by weight of cream powder; from about 7 to about 15% by weight of sugar; from about 2.0 to about 6.0% by weight cream flavoring; and from about 1.0 to about 2.0% by weight of salt.

According to a fourth aspect of the present invention, a powdered creamer product includes from about 70 to about 90% by weight of cream powder; from about 1.0 to about 2.0% by weight of titanium dioxide; from about 7 to about 15% by weight of sugar; and from about 1.0 to about 2.0% by weight of salt.

According to a fifth aspect of the present invention, a powdered creamer product includes from about 70 to about 90% by weight of cream powder; from about 0.5 to about 1.0% by weight of sodium alginate; from about 7 to about 15% by weight of sugar; and from about 1.0 to about 2.0% by weight of salt.

According to a sixth aspect of the present invention, a powdered creamer product includes from about 70 to about 90% by weight of cream powder; from about 0.5 to about 2.0% by weight of propylene glycol alginate; from about 7 to about 15% by weight of sugar; and from about 1.0 to about 2.0% by weight of salt.

According to an seventh aspect of the present invention, a powdered creamer product includes from about 70 to about 90% by weight of cream powder; from about 0.5 to about 2.0% by weight of hydrocolloid; from about 7 to about 15% by weight of sugar; and from about 1.0 to about 2.0% by weight of salt.

According to a eighth aspect of the present invention, a powdered creamer product includes from about 70 to about 90% by weight of cream powder; from about 0.05 to about 0.15% by weight of artificial sweetener; from about 7 to about 15% by weight of sugar; and from about 1.0 to about 2.0% by weight of salt.

According to a ninth aspect of the present invention, a method is provided for preparing a dry creamer. The method includes the steps of providing one or more textural ingredients in amounts sufficient to match the texture of a natural creamer; providing one or more appearance ingredients in amounts sufficient to match the appearance of a natural creamer; and providing one or more flavor/aroma ingredients in amounts sufficient to match the flavor and aroma of a natural creamer. The textural ingredients, appearance ingredients, and flavor/aroma ingredients are combined to form said dry creamer.

According to a tenth aspect of the present invention, a method is provided for producing a creamer system having a preselected sensory profile. The method includes the steps of providing one or more texture components selected from the group consisting of milk powder, cream powder, milk protein, vegetable fat, animal fat, sodium alginate, propylene glycol alginate, hydrocolloids, vegetable protein, starches, and emulsifiers, said texture components affecting the texture of the creamer; providing one or more appearance components selected from the group consisting of milk fat, milk protein, titanium dioxide, food coloring, sodium alginate, propylene glycol alginate, and hydrocolloids, said appearance components affecting the appearance of the creamer; and providing one or more flavor/aroma components selected from the group consisting of concentrated milk flavor, concentrated cream flavor, natural sweetener, artificial sweetener, salt, and fatty acids, said flavor/aroma components affecting the flavor and aroma of the creamer. The texture, appearance, and flavor/aroma components are blended together. According to a further aspect, the preselected sensory profile of said creamer system matches a sensory profile of a natural creamer selected from the group consisting of fluid whole milk, fluid lowfat milk, fluid nonfat milk, sweetened condensed milk, heavy cream, and half-and-half when said dry creamer system is hydrated.

### DETAILED DESCRIPTION OF THE PRESENTLY PREFERRED EXEMPLARY EMBODIMENTS

### 1. Introduction

As discussed above, there is a need in the art for a creamer system having a higher bulk volume and lower cost than traditional natural creamer systems, and preferably such a creamer can be customized to meet desired sensory characteristics, such as the sensory characteristics of natural creamers.

The concepts of the present invention will now be described with respect to a creamer system and a method for providing a creamer product having a sensory profile that may be customized to match the sensory profile of a specific natural creamer, or customized to have characteristics consistent with natural creamers but not identical to those of any specific natural creamer, or customized to provide any desired sensory characteristics. In a preferred exemplary application, a creamer system and method are provided that match fully and accurately the sensory profile of fluid whole milk, either when reconstituted in water, or when reconstituted in a beverage, soup, or food product. However, it is to be understood that methods of the present invention find equal applicability to many creamers having sensory profiles that do not match the sensory profile of fluid whole milk.

Four dimensions fully and accurately describe the sensory profile of any creamer (including fluid whole milk) prior to manipulation in a specific application: Texture, Appearance, Flavor, and Aroma. Additional dimensions may be used to describe creamers as they are manipulated in specific applications. For example, in some baking applications it is relevant to evaluate the Browning properties of the creamer. Similarly, in hot-beverage applications it is relevant to evaluate the Frothing properties of the creamer.

Each of the four dimensions is in turn described by specific sensory attributes. Because the descriptive language of creamer systems has not been standardized, others of skill in the art may not use the same sensory attributes (perhaps even the same dimensions) used herein for sensory description. However, an alternative sensory language that is accurate and complete should be easily translatable, by those skilled in the art, to the language herein.

It is important to note that the sensory profile of creamers, including natural creamers, vary depending upon the application. For example, the sensory profile of standalone fluid whole milk is very different from the sensory profile (or, perhaps more accurately, the sensory contribution) of fluid whole milk as used in a chocolate-raspberry-mango cake. The particularly preferred embodiment of the invention matches fully and accurately the sensory profile of standalone fluid creamers when reconstituted in water (such as standalone fluid whole milk), which is the state in which their sensory properties are perceived most completely. Also within the scope of the present invention is a creamer that fully and accurately matches the sensory contribution of standalone fluid creamers as used in a particular application, such as when reconstituted in a beverage, soup, or food product. As such, those skilled in the art will find it easy to apply the method in the envisioned invention for use in applications in which a perfect match is not required due to masking by other ingredients.

It is also important to note that perception of sensory attributes in creamers is not necessarily linearly correlated to ingredient levels. It has been discovered during the development of the present invention that the properties of the various natural creamers can be envisioned as part of a continuum. For example, the gain in Residual Mouthfeel (part of the Texture dimension) is mush more pronounced between fluid nonfat milk and 1% milkfat fluid milk than between 1% milkfat fluid milk and 2% milkfat fluid milk. As a result, the envisioned invention does not focus solely on ingredient levels believed to achieve specific sensory profiles, but instead also focuses on a system and method for manipulating specific sensory attributes of the creamer product.

### 2. The System

A model creamer according to the present invention will be described herein for purposes of illustration.

An ideal model creamer according to a presently preferred embodiment of the present invention includes one or more of the following ingredients:

4.5-6.5 g 72%-milkfat cream powder;

0.025-0.075 g sodium alginate with viscosity of from about 750 to about 850 mPAs in a 1% solution;

0.05-0.25 g titanium dioxide;

0.05-0.5 g concentrated milk and/or cream flavor;

0.5-1.0 g sucrose;

less than 0.1 g Sucralose brand artificial sweetener; and

0.05-0.15 g salt.

These amounts are based on a creamer that is intended to be reconstituted in 100 g of water. Those skilled in the art will be readily able to prepare larger or smaller amounts of the creamers according to the invention, as desired. The amounts given above are suggested ranges, but the invention is not limited only to creamers falling within these ranges, as can be appreciated based on the continuum effect discussed above.

It is envisioned that other creamers according to the present invention may also be prepared, including different or additional ingredients. Such different or additional ingredients considered to be within the scope of the present invention include, but are not limited to, cream powders having different levels of milkfat, milk powders, vegetable, animal, and/or synthetic fats, other thickening agents, other coloring agents, other flavoring agents, different sugars or artificial sweeteners, and lower-sodium salt replacement products. Those skilled in the art will readily appreciate how to substitute or supplement the creamers of the preferred embodiment with alternative ingredients, such as those listed above.

This model creamer will be further described in terms of the four basic sensory dimensions (Texture, Appearance, Flavor, and Aroma) and Frothing. The model creamer is in powdered form (meant to be rehydrated), and designed to reduce the physical volume and mass required to match the sensory properties of fluid creamers, particularly natural fluid creamers. As such, the model creamer described below will be particularly suited for use in powdered hot beverages and as a creamer in vending machines.

Texture

The Texture of any creamer product can be assessed using three desirable Texture sensory attributes: Thickness, Mouthcoating, and Residual Mouthcoating. Cream powder is a dry dairy product that is well-suited for use in achieving Thickness, Mouthcoating, and Residual Mouthcoating that are similar or identical to that of natural creamer products, and use of cream powder in the creamer system of the present invention is a presently preferred embodiment. A typical cream powder might contain the following ingredients by weight: 73% milkfat, 14% carbohydrate, 10% protein, 2% ash, and 1% moisture.

Texture may be enhanced further by adding one or more food-grade thickeners (including without limitation hydrocolloids such as sodium alginates or propylene glycol alginates) to the cream powder. A presently preferred embodiment of the creamer system of the present invention optionally includes the use of sodium alginates, including without limitation sodium alginates with a viscosity of 750-850 mPAs in a 1% solution. Unlike cream powders, which impact all four basic dimensions because of their milkfat, the impact of such thickeners is largely restricted to Texture, with a much smaller impact on Appearance. As a result, the addition of such thickeners in the creamer system of the present invention is a presently preferred embodiment when Texture is to be enhanced but the addition of more cream powder is not desirable. (Reasons for not adding more cream powder include without limitation: Aroma and Flavor—which cream powders enhance—are already at their optimal levels; or less cream powder is to be used because of considerations of cost or bulk.) The addition of such thickeners is also appropriate when a cream powder with a lower milkfat content (say, 40% by weight) is being used.

Texture may also be enhanced by adding proteins to the cream powder. Examples of such proteins include without limitation dairy proteins, and vegetable proteins such as soy proteins. Compared to thickeners, proteins (specifically dairy proteins) as a rule have a smaller impact on Texture and larger impact on Appearance, but like thickeners they also do not impact Aroma and Flavor.

Texture may also be enhanced by adding fats other than milkfat, or by adding starches and emulsifiers. Examples of such fats include, without limitation, vegetable fats such as coconut, palm, and palm kernel oils, animal fats, and synthetic fats, such as olestra.

As an example of a texturizing agent, rehydrating from about 4.5 to about 6.5 grams of cream powder containing about 72% milkfat (“Cream Powder”), and from about 0.025 to about 0.075 grams of sodium alginate in a 1% solution having a viscosity of 750-850 mPA (“Sodium Alginate”), in 100 ml of water results in a full and accurate match with the Texture of fluid whole milk. (100 ml of water has a mass of 100 grams, so these amounts of Cream Powder and Sodium Alginate translate approximately into 4.5-6.5% and less than 0.1% of the mass of the reconstituted creamer, respectively.) In order to obtain a creamer matching the Texture profile of a different creamer product, such as 1% milkfat fluid milk (commonly known as skim milk), from about 1.4 to about 2.0 grams of Cream Powder and from about 0.01 to about 0.05 grams of Sodium Alginate are rehydrated in 100 ml of water. In order to match the Texture profile of half-and-half, from about 16 to about 19 grams of Cream Powder and from about 0.05 to about 0.15 grams of Sodium Alginate are rehydrated in 100 ml of water.

Those skilled in the art will recognize readily that the Sodium Alginate cited here for the sake of illustration may be replaced easily by other sodium alginates used at different levels. For example, a sodium alginate with a viscosity of 1,000-1,500 mPas in a 1% solution may replace the Sodium Alginate at a different level. Furthermore, those skilled in the art will recognize readily that the Sodium Alginate may be supplemented with or replaced by other ingredients if there are problems dissolving the Cream Powder and Sodium Alginate in water. (Such problems may occur because of the protein present in the Cream Powder, the extent of the problem depends on the brand and protein level of Cream Powder used.) Examples of such ingredients include without limitation: addition of phosphates to supplement the Sodium Alginate, or replacing the Sodium Alginate with a Propylene Glycol Alginate.

Generally speaking, to match fully and accurately the sensory profile of a natural standalone fluid creamer such as fluid whole milk, a combination of Cream Powder and Thickener (most preferably the Sodium Alginate or Propylene Glycol Alginate) is used in the creamer system according to the present invention. The Cream Powder is used at a level that ranges from slightly less than the milkfat level being matched to modestly higher than the milkfat level being matched. For example, to match fully and accurately the sensory profile of fluid whole milk (which has a milkfat of 3-4% by weight), between 4.5-6.5 grams of (72% milkfat) Cream Powder are diluted in 100 ml of water. The resulting solution will have a milkfat level in the range of about 3.4%-4.1%, but there will be a small gap in Texture compared with fluid whole milk because the solution contains far less protein than that in fluid whole milk. The addition of a Thickener (such as 0.03-0.08 grams of the Sodium Alginate in this case) fully closes the gap in Texture. Where other ingredients in the finished beverage or food product may mask the difference in Texture as compared to whole milk, it may be possible to omit the use of the Thickener in accordance with the present invention.

Milkfat, and by extension cream powders, impact all four sensory dimensions (Texture, Appearance, Flavor, and Aroma). As a result, when the goal is to achieve a full and accurate match with an existing natural creamer, Cream Powder is used at a level that ranges from slightly less than the milkfat level being matched to modestly higher than the milkfat level being matched. This way, the contribution of milkfat to the other dimensions (say, Flavor and Aroma) remains at a level comparable to the natural creamer being matched, and a Thickener is used to close fully the gap in Texture. Of course, the Thickener is not necessary if the goal is not to achieve a full and accurate match with an existing natural creamer, but merely to achieve a product that has other pleasant properties of an existing natural creamer. For example, if the goal is to produce a creamer that is similar, but not identical, to fluid whole milk, those skilled in the art will simply use a higher level of Cream Powder (for example, 7-8 grams in 100 ml of water, resulting in a milkfat level of 4.7-5.3% and a richer Flavor and Aroma) and dispense with the Thickener altogether.

The particular application for the creamer system may also impact the level of Cream Powder and Thickener used. For example, in hot beverages (including without limitation lattes, hot chocolate, café au laits, and similar beverages dispensed by vending machines) the creamer system plays a prominent sensory role, and it is desirable to match fully and accurately the Thickness, Mouthcoating, and Residual Mouthcoating of fluid whole milk. In such an application, it is preferred to use Cream Powder at a level that ranges from slightly less than the milkfat level being matched to modestly higher than the milkfat level being matched, and supplement the Cream Powder with the addition of Thickener. However, in the case of flavored smoothies or shakes where Thickness (and perhaps Mouthcoating) is much more salient than Residual Mouthcoating, it is also possible to use a much lower level of Cream Powder and higher levels of Thickener.

The addition of milk proteins will achieve a similar effect on Texture if either less cream powder is used or a lower-milkfat cream powder is used. This allows for the production of a lower fat creamer product having Texture characteristics similar to those of higher fat natural creamers.

Optionally, the cream powder may be blended with vegetable or animal fats if the application does not require such a full and accurate match and/or the application introduces other ingredients that mask the Texture differences between milkfat and other types of fat. For example, a powdered hot-chocolate drink mix may substitute a certain amount of cream powder with other vegetable and/or animal fats.

In addition to the favorable and desirable Texture attributes of creamers, including Thickness, Mouthcoating, and Residual Mouthcoating, the Texture of natural creamers may also include two undesirable sensory attributes, Chalkiness and Astringency. These two undesirable attributes are mostly noticed because of the presence of lactose in natural creamers. A major advantage of the creamer system envisioned by this invention is that such a system does not exhibit these two undesirable attributes: the Cream Powder in the preferred embodiment contains very little lactose. This advantage also renders the creamers of the present invention useful for creating creamers for persons affected by lactose intolerance.

Appearance

The sensory scores of all five sensory attributes related to Appearance (Center Color, Edge Color, Transparency, Glass Coating, and Visual Thickness) can be increased simultaneously by increasing the level of milkfat (typically accomplished by adding more cream powder) or by adding milk proteins, or by doing both.

For all practical purposes, adding from about 1.0 to about 3.0 weight % of the final creamer powder of Titanium Dioxide will result in Center Color, Edge Color, and Transparency that match those of fluid whole milk. A small gap, undetectable by most consumers, will remain because the color of fluid whole milk is Yellow and Blue as well as White. This small gap may be closed, if desired, by adding small amounts of Yellow and smaller amounts of Blue food-grade coloring. The Center Color, Edge Color, and Transparency of other natural creamer products varies according to fat and protein content, and may also be replicated by addition of appropriate quantities of titanium dioxide and food coloring.

The scores of the Glass Coating and Visual Thickness sensory attributes can be increased by adding a small amount of food-grade thickener. According to a presently preferred embodiment a hydrocolloid is used, and according to a particularly preferred embodiment the hydrocolloid is sodium alginate or propylene glycol alginate. The addition of such a thickener will also impact the Texture properties of the creamer system, but will do so in a manner that is consistent with the increase in Glass Coating and Visual Thickness.

The scores of most sensory attributes related to Appearance may also be improved, in an alternative embodiment, by adding other opacifiers with a very small particle size. Those skilled in the art will recognize readily that proteins (particularly dairy proteins such as whey protein) will replace, or more preferably, supplement the titanium dioxide if necessary. The addition of such proteins will again impact the Texture properties of the creamer system, but will do so in a manner that is consistent with the increase in scores related to Appearance.

Flavor and Aroma

Positive sensory attributes making up the flavor and aroma dimensions include Raw Cream, Cooked, Sweet Taste, and Salty Taste. These can be matched accurately and fully by adding the following presently preferred ingredients: a concentrated cream or milk flavoring (preferably added pursuant to the manufacturer's directions); sucrose or common table sugar (preferably added in an amount from about 7 to about 15 weight % of the dry creamer); and table salt (preferably added in an amount from about 1 to about 2 weight % of the dry creamer). Concentrated cream or milk flavorings are widely available from a variety of manufacturers of flavors; the usage rate depends on the actual brand used.

These three ingredients accurately and fully match the positive sensory attributes of Flavor and Aroma. Other flavorings, sweeteners, and salts may also be used in accordance with the present invention, as appropriate. For example, fatty acids having the same profile as milkfat (such as butyric acid) may be used. Furthermore, lactose powder may optionally be added to enhance the Flavor and Aroma. Artificial sweeteners may also be used in place of sucrose, lactose, or other natural sweeteners, if a lower-calorie product is desirable in a particular context. Such artificial sweeteners, which may include saccharine, aspartame, and sucralose, may also be used in conjunction with natural sweeteners. Dietary concerns may also dictate the use of a low-sodium salt replacement product in lieu of table salt.

Negative sensory attributes include Stale and Grassy. These undesirable dimensions can usually be completely eliminated using the creamer systems of the present invention. The cream powder, milk proteins, and other components used in the system of the present invention can be standardized, and have long shelf lives, thereby minimizing the likelihood that the resulting creamer will exhibit these negative characteristics.

Frothing

The 72% milkfat cream powder used in the preferred embodiments of the present invention contains protein that produces a froth in the creamer system upon agitation and/or the introduction of air. For a richer froth, as is desirable for applications where foamed milk is an important ingredient, such as cappuccino beverages, additional milk proteins or a frothing agent (e.g., a powder with encapsulated air) may be added to improve the frothing characteristics of the creamer.

### 3. The Method

Particularly preferred creamer products according to this invention may be prepared by mixing ingredients such as milk powder or cream powder, sweetener, and salt with optional additional flavoring and coloring agents, and texturizers, in order to form a finished creamer product having a desired sensory profile. The sensory profile may closely mimic a particular natural creamer, may blend qualities from multiple natural creamers, or may even be customized for a particular application without mimicking any particular natural creamer.

The creamer system ingredients should be thoroughly mixed and blended to form the finished creamer product. The powdered creamer mix may then be instantized or agglomerated using methods known to those skilled in the art in order to improve the solubility of the creamer powder in water.

The creamer produced according to the methods of the present invention may then be incorporated into dry mix products, such as instant beverages, baked goods, sauces, and soup bases. The creamers may also be stored for later use in beverages and foods, including without limitation being incorporated into a storage compartment of a vending apparatus for use in preparing vended beverages and soups.

### 4. Examples

The preferred embodiments of the present invention will now be set forth in the following non-limiting examples.

### Example 1

The powdered ingredient levels described below are those recommended to produce a powdered creamer having a sensory profile similar or identical to that of whole milk when reconstituted in 100 ml of water:

| Ingredient | Weight (grams) | Weight % |
|---|---|---|
| 72% milkfat Cream Powder | 5.600 | 79.9% |
| Sodium Alginate | 0.050 | 0.7% |
| Titanium Dioxide | 0.150 | 2.1% |
| Cream Flavor | 0.300 | 4.3% |
| Salt | 0.100 | 1.4% |
| Sucrose | 0.800 | 11.4% |
| Sucralose | 0.0045 | 0.1% |
| Total | 7.0045 grams | 100.0% |

The powdered ingredients are blended until an even consistency is achieved, and then instantized/agglomerated using processes known to those skilled in the art. If vacuum-packed or hermetically sealed with an inert gas (such as a nitrogen flush), the powdered creamer may be stored for about 6 months before use under normal conditions without any perceptible loss of quality.

### Example 2

The powdered creamer system prepared in Example 1 was rehydrated in 100 ml of water until the powder was fully dissolved. The resulting creamer was observed for the dimensions of Texture, Appearance, Flavor, and Aroma, and exhibited characteristics similar to those of fluid whole milk.

### Example 3

The powdered creamer system prepared in Example 1 was rehydrated in 100 ml of black coffee until the powder was fully dissolved. The resulting beverage was observed for the dimensions of Texture, Appearance, Flavor, and Aroma, and exhibited characteristics similar to those of a latte or of a café au lait.

### 5. Conclusion

Thus, what has been described is a system and method for providing creamers that have sensory characteristics matched to characteristics of actual creamer products, or that have sensory characteristics consistent with actual creamers. The system and method allow customization of the creamer product to match any desired characteristics, while reducing costs and bulk density.

It is to be understood that the present invention is not limited in its application to the presently preferred ingredients set forth herein, or to the combinations of ingredients and methods of combining them set forth in the foregoing description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

All U.S. and foreign patent documents discussed above are hereby incorporated by reference into the Detailed Description of the Presently Preferred Embodiments.

What is claimed is:

1. A creamer system having a sensory profile, comprising:
one or more texture components selected from the group consisting of milk powder, cream powder, milk protein, vegetable fat, animal fat, sodium alginate, propylene glycol alginate, hydrocolloids, vegetable protein, starches, and emulsifiers, said texture components affecting the texture of the creamer;
one or more appearance components selected from the group consisting of milk fat, milk protein, titanium dioxide, food coloring, sodium alginate, propylene glycol alginate, and hydrocolloids, said appearance components affecting the appearance of the creamer; and
one or more flavor/aroma components selected from the group consisting of concentrated milk flavor, concentrated cream flavor, natural sweetener, artificial sweetener, salt, and fatty acids, said flavor/aroma components affecting the flavor and aroma of the creamer; and
wherein the sensory profile of said creamer system matches the sensory profile of one or more natural creamers selected from the group consisting of fluid whole milk, fluid lowfat milk, fluid nonfat milk, sweetened condensed milk, heavy cream, and half-and-half when said creamer system is hydrated.

2. The creamer system of claim 1, wherein the sensory profile matches the sensory profile of a single natural creamer.

3. A powdered creamer product, comprising:
from about 70 to about 90% by weight of cream powder;
from about 7 to about 15% by weight of sugar; and
from about 1.0 to about 2.0% by weight of salt.

4. The powdered creamer product of claim 3, further comprising from about 0.05 to about 0.15% by weight of artificial sweetener.

5. The powdered creamer product of claim 3, further comprising from about 1.0 to about 2.0% by weight of titanium dioxide.

6. The powdered creamer product of claim 3, further comprising from about 0.5 to about 1.0% by weight of sodium alginate.

7. The powdered creamer product of claim 3, further comprising from about 0.5 to about 2.0% by weight of propylene glycol alginate.

8. The powdered creamer product of claim 3, further comprising from about 0.5 to about 2.0% by weight of hydrocolloid.

9. The powdered creamer product of claim 3, further comprising from about 2.0 to about 6.0% by weight cream flavoring.

10. The powdered creamer product of claim 3, wherein the powdered creamer product mimics sensory attributes of a single natural creamer.

11. The powdered creamer product of claim 10, wherein the single natural creamer is selected from the group consisting of skim milk, whole milk, half-and-half, and whole cream.

12. The powdered creamer product of claim 3, wherein the powdered creamer product has sensory attributes consistent with existing natural creamers.

13. The powdered creamer product of claim 12, wherein existing natural creamers are natural dairy creamers selected from the group consisting of fluid whole milk, fluid low-fat milk, half-and-half, and sweetened condensed milk.

14. A method for preparing a dry creamer, comprising the steps of:
providing one or more textural ingredients in amounts sufficient to match the texture of a natural creamer;
providing one or more appearance ingredients in amounts sufficient to match the appearance of a natural creamer; and
providing one or more flavor/aroma ingredients in amounts sufficient to match the flavor and aroma of a natural creamer,
wherein said textural ingredients, appearance ingredients, and flavor/aroma ingredients are combined to form said dry creamer.

15. The method of claim 14, wherein the texture of a natural creamer, appearance of a natural creamer, and flavor and aroma of a natural creamer are all characteristics of a single natural creamer.

16. The method of claim 15, wherein said single natural creamer is selected from the group consisting of skim milk, whole milk, half-and-half, and whole cream.

17. The method of claim 14, wherein the texture of a natural creamer, appearance of a natural creamer, and flavor and aroma of a natural creamer are consistent with existing natural creamers.

18. The method of claim 17, wherein said natural creamers are natural dairy creamers selected from the group consisting of fluid whole milk, fluid low-fat milk, half-and-half, and sweetened condensed milk.

19. A method for producing a creamer system having a preselected sensory profile, comprising the steps of:
providing one or more texture components selected from the group consisting of milk powder, cream powder, milk protein, vegetable fat, animal fat, sodium alginate, propylene glycol alginate, hydrocolloids, vegetable protein, starches, and emulsifiers, said texture components affecting the texture of the creamer;
providing one or more appearance components selected from the group consisting of milk fat, milk protein, titanium dioxide, food coloring, sodium alginate, propylene glycol alginate, and hydrocolloids, said appearance components affecting the appearance of the creamer; and
providing one or more flavor/aroma components selected from the group consisting of concentrated milk flavor, concentrated cream flavor, natural sweetener, artificial sweetener, salt, and fatty acids, said flavor/aroma components affecting the flavor and aroma of the creamer; and
blending said texture, appearance, and flavor/aroma components.

20. The method of claim 19, wherein the preselected sensory profile of said creamer system matches a sensory profile of a natural creamer selected from the group consisting of fluid whole milk, fluid lowfat milk, fluid nonfat milk, sweetened condensed milk, heavy cream, and half-and-half when said dry creamer system is hydrated.
